(19) United States
(12) Patent Application Publication
(10) Pub. No.: US 2020/0133682 A1
(43) Pub. Date: Apr. 30, 2020

(54) SYSTEM AND METHOD FOR AUTOMATICALLY RECONFIGURING A COMPUTER BETWEEN A CRYPTOCURRENCY MINING MODE AND A GAMING MODE

(71) Applicant: FEAT CAPITAL LLC, KEY BISCAYNE, FL (US)

(72) Inventor: Cristina Nordskog Vallandro do Valle, Miami, FL (US)

(73) Assignee: FEAT CAPITAL LLC, KEY BISCAYNE, FL (US)

(21) Appl. No.: 16/531,906

(22) Filed: Aug. 5, 2019

Related U.S. Application Data
(60) Provisional application No. 62/751,920, filed on Oct. 29, 2018.

(51) Int. Cl. G06F 9/4401; G06Q 20/36

(52) U.S. Cl. CPC G06F 9/4403; G06F 9/4405; G06Q 20/3672

(57) ABSTRACT

A system, method, and apparatus for reconfiguration of a computer from a gaming/graphics mode to cryptocurrency mining/compute mode, and cryptocurrency mining/compute to gaming/graphics mode automatically, including performance optimization in both modes. The system switches operating parameters of one or more Graphics Processing Units (GPU's) between compute and graphics modes automatically with mode performance optimization. The invention solves the problem of switching back and forth between graphics and compute mode automatically (without the need for extensive programming) and ensures that the PC/GPU's with run safely (without overheating) and profitably within both modes. The system may also include a dashboard that can be used to see the operational efficiency of the user's GPU's in compute/mining mode.

### CROSS-REFERENCE TO RELATED APPLICATION

This application claims the benefit of priority of U.S. provisional application No. 62/751,920, filed Oct. 29, 2018, the contents of which are herein incorporated by reference.

### BACKGROUND OF THE INVENTION

The present invention relates to computing systems, and more particularly to configuring computing system for optimized performance in a desired operating mode.

It is difficult and labor intensive to reconfigure a computer from a gaming/graphics mode of operation to a cryptocurrency mining/computing mode and back without losing processing capacity on both functionalities. Currently, this is a very labor intensive, complicated, and error prone process.

Beginning with the AMD Radeon Crimson Relive Edition 17.10.2, AMD Drivers allow graphical processing units (GPUs) to be optimized for a graphics or a computing workload, where the compute mode is specifically designed for mining and the graphics mode configured for gaming and other graphics intensive processing.

The GPU workload can be changed manually using the AMD Driver's configuration graphical user interface (GUI). The GUI must be applied for each GPU in the system, and the GPUs should be restarted to apply changes. This process can be tedious for the user, especially in multi-GPU systems, where the user should apply this process to one GPU at a time.

As can be seen, there is a need for improved systems, methods, and apparatus that allows users to switch back and forth between gaming and mining without having to invest time in programming and setting up their equipment.

### SUMMARY OF THE INVENTION

In one aspect of the present invention, a method of automatically configuring a computing system between a graphics mode and a compute mode is disclosed. The method includes retrieving a quantity and a type specification of a graphics processing unit (GPU) installed in the computing system. A first set of predetermined operating parameters for each GPU based on the type specification is retrieved, the first set of predetermined operating parameters specifying settings of the GPU to operate in the compute mode. Each GPU is then configured with the first set of predetermined operating parameters. Each GPU is restarted to operate the GPU according to the first set of predetermined operating parameters.

In some embodiments, the first set of predetermined operating parameters includes a GPU memory clock setting. The first set of predetermined operating parameters may also include a GPU processor clock setting. The first set of predetermined operating parameters may also include a GPU processor voltage setting. In other embodiments, the first set of predetermined operating parameters are stored in a GPU data repository resident in a memory storage device of the computing system. In yet other embodiments, the GPU data repository is hosted on a server accessible via a computer network. In other embodiments, the first set of predetermined operating parameters are retrieved from the GPU repository.

In another embodiment, the method also includes configuring each GPU to a second set of predetermined operating parameters corresponding to the graphics mode. Each GPU is then restarted with the second set of predetermined operating parameters.

In other aspects of the invention, a method of configuring a computing system between a cryptocurrency mining mode and a graphics processing mode is disclosed. The method includes launching a cryptocurrency mining script configured to operate the computing system in a cryptocurrency mining mode. A serial number associated with a motherboard of the computer is determined. The serial number is checked to determine if it is registered with a cryptocurrency mining service. When the serial number is registered with the cryptocurrency mining service, a determination is made as to whether a valid cryptocurrency mining account is configured. When a valid cryptocurrency mining account is configured, a quantity and a type specification of a graphics processing unit (GPU) installed in the computing system is retrieved. A first set of predetermined operating parameters for each GPU, based on the type specification, is received. The first set of predetermined operating parameters specify settings of each GPU to operate in the cryptocurrency mining mode. Each GPU is then configured with the first set of predetermined operating parameters. Once configured, each GPU is restarted to operate the GPU according to the first set of predetermined operating parameters.

In other embodiments of the invention, a cryptocurrency client is activated. The cryptocurrency client then mines the cryptocurrency. The mined cryptocurrency is then deposited at a wallet address associated with the valid cryptocurrency account.

In other embodiments, when a valid cryptocurrency account is not configured, the valid cryptocurrency account is established. This embodiment of the method includes receiving a cryptocurrency wallet address from a user of the valid cryptocurrency account and verifying the cryptocurrency wallet address.

In other embodiments, the method includes exiting the cryptocurrency client. When the cryptocurrency client is exited, a second set of predetermined operating parameters corresponding to the graphics mode for each GPU are retrieved. Each GPU is then configured with the second set of predetermined operating parameters. Once configured, each GPU is restarted to operate the GPU in the graphics mode according to the second set of predetermined operating parameters.

In yet other aspects of the invention, a computerized system for cryptocurrency mining is disclosed. The system includes a computer having a motherboard, a processor, a user interface, and at least one graphical processing unit (GPU). The GPU has a memory clock and a processor. A server hosting a cryptocurrency mining service is accessible by the computer via a communications network. The system includes a program product having machine-readable program code for causing, when executed, the computer to perform process steps. The process steps include launching a cryptocurrency mining script configured to operate the computing system in a cryptocurrency mining mode. The script determines a serial number associated with a motherboard of the computer. A determination is made as to whether the serial number is registered with the cryptocurrency mining service. When the serial number is registered with the cryptocurrency mining service, a determination is made whether a valid cryptocurrency mining account with the cryptocurrency mining service is configured. When a valid cryptocurrency mining account is configured, a quantity and a type specification of the graphics processing unit (GPU) installed in the computing system is retrieved. A first set of predetermined operating parameters for each GPU based on the type specification is then retrieved. The first set of predetermined operating parameters specify settings of each GPU to operate in the cryptocurrency mining mode. Each GPU is then configured with the first set of predetermined operating parameters. Each GPU is then restarted to operate the GPU according to the first set of predetermined operating parameters.

The system may also include the process steps of activating a cryptocurrency client and mining a crypto currency via the cryptocurrency client. The cryptocurrency client is configured to deposit the mined cryptocurrency at a wallet address associated with the valid cryptocurrency account.

In some embodiments, when a valid cryptocurrency account is not configured, the valid cryptocurrency account is established with the cryptocurrency mining service. A cryptocurrency wallet address is received from a user of the valid cryptocurrency account. The cryptocurrency wallet address is then verified and associated with the valid cryptocurrency account.

In other embodiments, the process steps include exiting the cryptocurrency client and retrieving a second set of predetermined operating parameters corresponding to the graphics mode for each GPU. Each GPU is then configured with the second set of predetermined operating parameters and restarted to operate the GPU in the graphics mode according to the second set of predetermined operating parameters.

In yet other embodiments, the system may include a GPU data repository storing the first set of predetermined operating parameters according to the type specification for the GPU. In this embodiment, the process steps include retrieving the first set of predetermined operating parameters from the GPU data repository.

These and other features, aspects and advantages of the present invention will become better understood with reference to the following drawings, description and claims.

### BRIEF DESCRIPTION OF THE DRAWINGS

FIG. 1 is a flow chart of a mining mode configuration script;

FIG. 2 is a flow chart showing a gaming mode configuration script;

FIG. 3A is a flow chart of the start process; and

FIG. 3B is a flow chart of the stop process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, and apparatus that automatically reconfigures computers between a gaming/graphics mode to a cryptocurrency mining/computing mode, and from the cryptocurrency mining mode back to the gaming mode. The reconfiguration optimizes settings of a graphics processing unit (GPU) on the computing system for maximum processing performance and minimizing electricity consumption in the “compute” (cryptocurrency mining) and the “graphics” (Gaming or other graphics application) modes.

Cryptocurrency miners and gamers use the same expensive computing equipment. While the computing equipment for each application, mining or gaming, is optimized for a particular “computing” or “graphics” end use, the equipment typically isn't reconfigurable by the end user. For example, GPU makers do not provide a seamless software for maximization of dual mode usage, particularly for multiple GPU computing systems. Likewise, there is presently no software that facilitates this for users.

Mining is a repetitive process where not all of the potential of the GPU is used. An understanding of how it works allows the user to apply settings which improve performance and reduce energy consumption at the same time. The ability to apply these changes impacts the profitability of the mining process because one of its biggest costs is related to electricity consumption.

Mining is an intensive process for a GPU memory but not for a GPU processor, so the goal is to increase GPU Memory Clock speeds to increase performance while reducing GPU Processor Voltage to reduce electrical consumption. As will be appreciated from the foregoing, reconfiguring the GPU performance parameters for a compute mode may also help to increase the GPU lifespan while mining because it reduces unused processor loads during the mining process and allows the GPUs to work at lower temperatures.

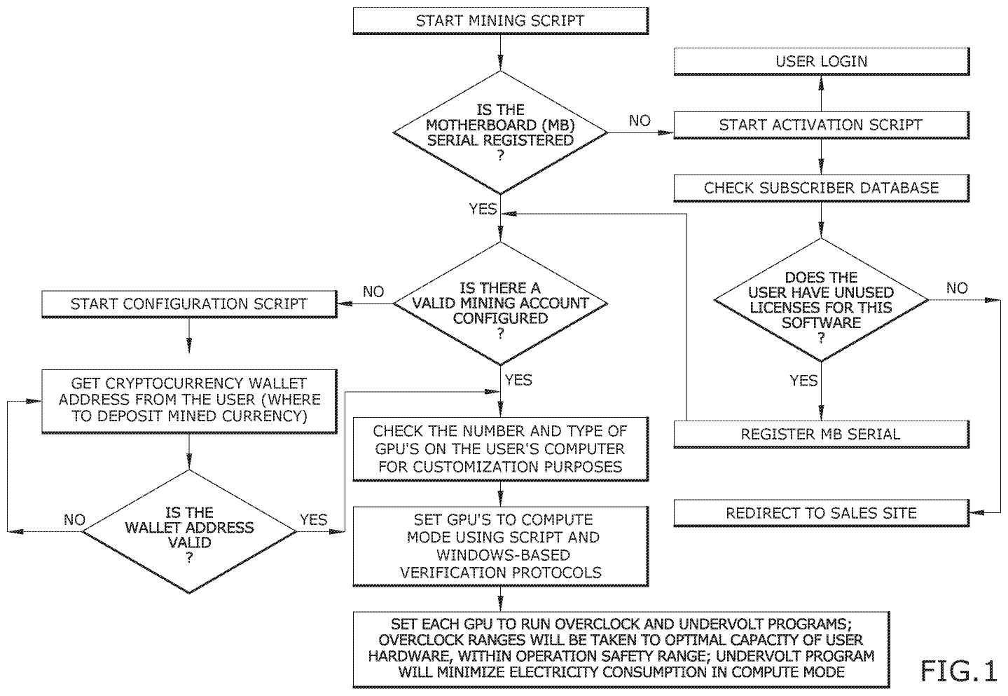

As seen in reference to FIG. 1, the system may be configured to determine whether a serial number of a computing system motherboard is registered with the system. When the motherboard serial number is registered, the system determines whether the user has a valid mining account. When the valid mining account exists, the system determines the number and type of GPUs on the user's computing system.

The number and type of GPUs may be determined by an Overdrivent application program interface (API), to get the list of GPUs connected to the user's computing device and their type specifications (including a series and a model number).

When the number and type of GPUs have been determined, the system configures each of the GPUs to a compute mode. The system is configured to retrieve a plurality of predetermined operating parameters for each of the GPUs. The predetermined operating parameters optimize one or more GPU resources, such as a GPU memory clock, a GPU processor clock, and a GPU operating voltage to configure the GPU performance for the computing mode. The plurality of predetermined parameters include a verified performance of the selected GPU type in the computing mode. The verified performance includes a prior configuration and satisfactory performance of the type GPU in the crypto currency mining mode.

The plurality of predetermined operating parameters may be stored in a GPU data repository. The data repository may be resident on the computing device to be configured or may be retrieved from a data repository resident on a server hosting a configuration service.

Each GPU is then configured according to the plurality of predetermined operating parameters. The GPU may then be restarted to begin operation in the compute mode according to the settings provided in the plurality of predetermined operating parameters. The user may then operate the computer to mine crypto currency while in the compute mode.

By way of non-limiting example, the compute mode may be configured by modifying specific values in a Windows Registry using a Python script. The GPU devices may then be restarted using Windows Device Console (Devcon.exe) commands to apply the new configuration settings according to the predetermined operating parameters.

When a valid mining account is not configured, a configuration script executes to obtain a cryptocurrency wallet address from the user. The cryptocurrency wallet is designated to allow cryptocurrency mined by the user to be deposited in their wallet. When the wallet address is valid, the system proceeds to reconfigure the GPUs to the mining mode, as previously described. When the wallet address is not valid, the user is prompted to enter a valid crypto currency wallet address.

To begin mining, the system generates a configuration script for a crypto currency mining application, such as Claymore, according to the values given by the user when registering their account. The system may include the mining client itself (Claymore) and a mining dashboard, a monitor which presents customizable information about the mining process, gathered from a Claymore API (for values related to the user's computing system) and from a Nanopool API (for values related to their mining production).

When the motherboard serial number is not registered, the system initiates an activation script, which allows the user to login, determine the existence of one or more unused licenses, and register the motherboard serial number to correspond with the unused licenses. The activation script allows the user to obtain an additional license if no unused licenses exist.

The system is configured to revert the computing system to the graphics mode when closing the mining client or dashboard according to one or more conventional process, such as closing the mining client application, using the Windows® task manager, or other control input for terminating the application. When the mining client is closed, the operation mode for each GPU is reset to the graphics mode, so the GPUs resources are optimized to for graphics processing instead of performing calculations.

The mode is configured modifying specific values in Windows Registry using a Python script and the devices are restarted using Windows Device Console (Devcon.exe) so they apply the graphics configuration settings. In the Devcon.exe is executed to restore a second set of predetermined parameters for the GPU corresponding to operation in the graphics mode. The second set of predetermined parameters include parameters for the memory clock and core voltage for each GPU.

When reverting to the graphics mode, the system retrieves the compatible hardware connected and applies a specific predetermined parameters for both GPU memory clock and GPU processor voltage for each GPU model. The predetermined parameters for each GPU have been collected and tested in many different GPUs, the parameters selected to provide a balance between performance and operational stability. Thus, the system interacts with AMD and Nvidia device drivers to set these values whenever the computing system is required to mine, and to release them when it's not.

Aspects of the present invention optimizes the GPU workload automatically, so that whenever the system is required to mine it will select performance parameters for a Compute mode for each of one or more GPUs in the system and will restart the one or more GPUs without requiring the user to take further actions. When the user switches mining mode OFF, it will set Graphics mode performance parameters for each GPU and will restart the GPU automatically.

Previously, once the operating parameters of the GPU's for a cryptocurrency mining computer has been configured to harness the GPUs capacity for computing tasks necessary for cryptocurrency mining, they lose some of their capacity for gaming. Conventionally, switching the GPU back to gaming mode at full graphics capacity requires a lot of programming that most users do not know how to execute.

According to the present invention, users no longer have to give up processing power in either gaming or mining modes. With the click of a button (graphical or even hardware) the user can seamlessly reconfigure the computer between the two modes with no extra programming configuration knowledge or skills. The present invention allows the user to produce cryptocurrency by allowing the user to receive rewards in a mining pool for the hash power generated by operation of their computer in the mining mode, when their computer is not engaged in gaming or graphics processing tasks.

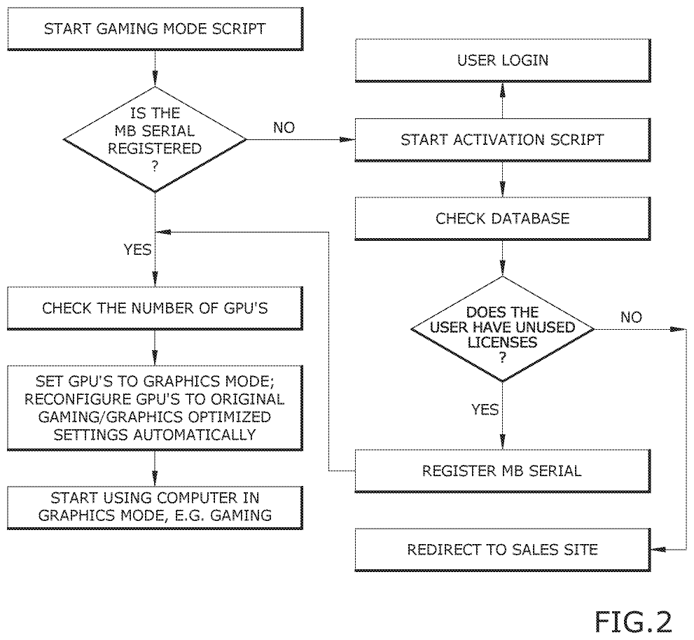

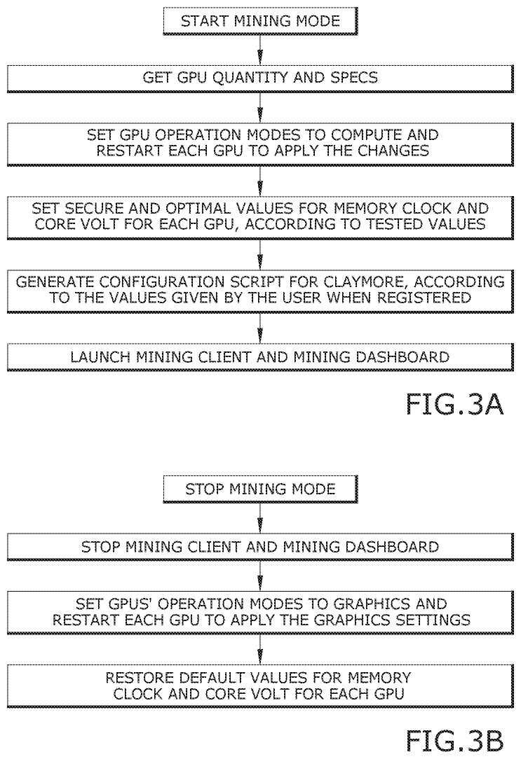

As seen in reference to the drawings of FIGS. 1 and 2, aspects of the present invention allow the user to switch, or reconfigure their computing system, for optimization in either a graphics or computing mode. In FIG. 1, the system prompts the user for linking processing power of the computer to a cryptocurrency mining pool. The system then configures the computer for activation of the cryptocurrency mining mode. The reconfiguration includes optimization of the GPU for maximization of hash computing power. The computer may also be reconfigured for minimization of electrical consumption during mining operations.

As seen in reference to FIG. 2, the system may reconfigure the computing system back to the gaming mode. In this instance, the GPUs are reconfigured for the Gaming mode, that is to maximize graphics processing capabilities of the GPUs. The computing system may also provide maximum processing power for graphics intensive applications, such as gaming. The user activates each of the steps, depending on which mode (gaming or cryptocurrency mining) with which they would like to run their equipment.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of automatically configuring a computing system between a graphics mode and a compute mode, comprising:
retrieving a quantity and a type specification of one or more graphics processing units (GPU) installed in the computing system;
retrieving a first set of predetermined operating parameters for each GPU based on the type specification each GPU, the first set of predetermined operating parameters specifying settings of the GPU to operate in the compute mode;
configuring each GPU with the first set of predetermined operating parameters; and
restarting each GPU to operate the GPU according to the first set of predetermined operating parameters.

2. The method of claim 1, wherein the first set of predetermined operating parameters includes a GPU memory clock setting.

3. The method of claim 2, wherein the first set of predetermined operating parameters includes a GPU processor clock setting.

4. The method of claim 3, wherein the first set of predetermined operating parameters includes a GPU processor voltage setting.

5. The method of claim 1, further comprising:
storing the first set of predetermined operating parameters in a GPU data repository resident in a memory storage device of the computing system.

6. The method of claim 1, further comprising:
hosting a GPU data repository on a server accessible via a computer network; and
retrieving the first set of predetermined operating parameters from the GPU data repository.

7. The method of claim 1, further comprising:
configuring each GPU to a second set of predetermined operating parameters corresponding to the graphics mode; and
restarting each GPU with the second set of predetermined operating parameters.

8. A method of configuring a computing system between a cryptocurrency mining mode and a graphics mode, comprising:
launching a cryptocurrency mining script configured to operate the computing system in the cryptocurrency mining mode;
determining a serial number associated with a motherboard of the computing system;
determining whether the serial number is registered with a cryptocurrency mining service;
when the serial number is registered with the cryptocurrency mining service,
determining whether a valid cryptocurrency mining account is configured;
when the valid cryptocurrency mining account is configured,
retrieving a quantity and a type specification of a graphics processing unit (GPU) installed in the computing system;
retrieving a first set of predetermined operating parameters for each GPU based on the type specification, the first set of predetermined operating parameters specifying settings of each GPU to operate in the cryptocurrency mining mode;
configuring each GPU with the first set of predetermined operating parameters; and
restarting each GPU to operate the GPU according to the first set of predetermined operating parameters.

9. The method of claim 8, further comprising:
when a valid cryptocurrency mining account is not configured, establishing the valid cryptocurrency account;
receiving a cryptocurrency wallet address from a user of the valid cryptocurrency account; and
verifying the cryptocurrency wallet address.

10. The method of claim 8, further comprising:
activating a cryptocurrency client; and
mining a crypto currency via the cryptocurrency client.

11. The method of claim 10, further comprising:
depositing at a wallet address associated with the valid cryptocurrency account.

12. The method of claim 10, further comprising:
exiting the cryptocurrency client;
retrieving a second set of predetermined operating parameters corresponding to the graphics mode for each GPU;
configuring each GPU with the second set of predetermined operating parameters; and
restarting each GPU to operate the GPU in the graphics mode according to the second set of predetermined operating parameters.

13. A computerized system for cryptocurrency mining, comprising:
a computer having a motherboard, a processor, and at least one graphical processing unit (GPU), the GPU having a memory clock and a GPU processor;
a server hosting a cryptocurrency mining service, accessible by the computer via a communications network;
the computer having a user interface operating in a graphics mode; and
a program product comprising machine-readable program code for causing, when executed, the computer to perform the following process steps:
launching a cryptocurrency mining script configured to operate the computing system in a cryptocurrency mining mode;
determining a serial number associated with the motherboard of the computer;
determining whether the serial number is registered with the cryptocurrency mining service;
when the serial number is registered with the cryptocurrency mining service,
determining whether a valid cryptocurrency mining account with the cryptocurrency mining service is configured;
when the valid cryptocurrency mining account is configured,
retrieving a quantity and a type specification of each GPU installed in the computing system;
retrieving a first set of predetermined operating parameters for each GPU based on the type specification of each GPU, the first set of predetermined operating parameters specifying settings of each GPU to operate in the cryptocurrency mining mode;
configuring each GPU with the first set of predetermined operating parameters; and
restarting each GPU to operate the GPU according to the first set of predetermined operating parameters.

14. The computerized system of claim 13, further comprising:
activating a cryptocurrency client; and
mining a crypto currency via the cryptocurrency client.

15. The computerized system of claim 14, further comprising:
depositing the cryptocurrency at a wallet address associated with the valid cryptocurrency account.

16. The computerized system of claim 13, further comprising:
when a valid cryptocurrency account is not configured,
establishing the valid cryptocurrency account with the cryptocurrency mining service;
receiving a cryptocurrency wallet address from a user of the valid cryptocurrency account;
verifying the cryptocurrency wallet address; and
associating the cryptocurrency wallet address with the valid cryptocurrency account.

17. The computerized system of claim 14, further comprising:
exiting the cryptocurrency client;
retrieving a second set of predetermined operating parameters corresponding to the graphics mode for each GPU;
configuring each GPU with the second set of predetermined operating parameters; and
restarting each GPU to operate the GPU in the graphics mode according to the second set of predetermined operating parameters.

18. The computerized system of claim 13, further comprising:
a GPU data repository storing the first set of predetermined operating parameters according to the type specification for the GPU.

19. The computer system of claim 18, further comprising:
retrieving the first set of predetermined operating parameters from the GPU data repository.
